(19) United States
(12) Patent Application Publication
(10) Pub. No.: US 2009/0080870 A1
(43) Pub. Date: Mar. 26, 2009

(54) Media Transcoding Device and Method

(76) Inventors: George S. Mudie, Cold Ash (Berkshire) (GB); Christopher Caines, Yateley (Guildford) (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/915,296

(22) PCT Filed: May 25, 2006
(86) PCT No.: PCT/GB2006/001930

§ 371 Date: Nov. 6, 2008

(30) Foreign Application Priority Data
May 2, 2005 (GB) 0510678.6

(51) Int. Cl. H04N 7/01

(52) U.S. Cl. 386/131; 386/E05.003

(57) ABSTRACT

A transcoding device includes an interface for receiving a media file in a first format, a transcoder for transcoding the media file to the second format, and output means for outputting the media file in a second format. The interface is preferably suitable for connection to a media file store, such as a PVR, so as to receive and transcode the media file to the second format for output to a portable media player (PMP).

### FIELD OF THE INVENTION

The present invention relates to a media transcoding device, particularly but not exclusively for transcoding media content recorded on a media recorder for playback on an alternative device, and a method of use of such a device.

### BACKGROUND OF THE INVENTION

In conventional Personal Video Recording (PVR) systems, such as the Sky⁺® system, a broadcast receiver or set-top box (STB) stores a schedule of programmes to be broadcast on different channels and at different times, and presents this schedule to the user in an interactive electronic programme guide (IEPG). The user selects desired programmes or series of programmes, which are then recorded on a local recording medium, such as a hard disc, as they are broadcast. The recorded programmes may then be viewed at a time convenient to the user, and may be stored for repeated viewing or erased automatically after they are viewed. The programmes are broadcast and stored in encrypted form, the decryption process being managed via a smart card. Some programmes may be provided on a ‘pay-per-view’ basis, so that they may only be viewed if an additional payment has been made and a specific authorisation sent to the STB.

Conventional PVR systems include audio and video outputs for connection of audio and video display equipment, either directly or wirelessly through a direct wireless link or ‘wireless sender’, allowing recorded programmes to be watched or listened to in the vicinity of the PVR. Portable media players are also available, for storing and playing back media files. It is desirable to export recorded programmes from a PVR to a portable media player so that they can be played back at a time and place convenient for the user, subject to any digital rights management (DRM) which the content provider may wish to impose. Conventional PVR systems inhibit access to digital media content by receiving and storing the media files in encrypted form and outputting video and/or audio signals only in analog form. If digital media content is to be exported from the PVR, it is desirable to enforce DRM at the portable media player.

Personal computers can be used to record media files to hard disc, transcode the media files to a suitable coding format for a portable media player, and export the transcoded media files to the portable media player. Software for performing these functions is included for example in Microsoft Windows XP Media Center Edition®. The media files may have been downloaded from a media source via the Internet, or received from a TV or radio broadcast using a suitable tuner card.

Transcoding and exporting media files from a general-purpose computer is relatively straightforward, as the computer is able to load and execute the necessary software for performing these functions. However, general-purpose computers often do not perform very well as PVRs, for example because their operating systems are not specifically designed for real-time functions such as media recording, and because of incompatibility with third-party tuner cards. Dedicated PVRs, such as the Sky⁺ STB, generally perform better as PVRs than is possible with general-purpose computers.

The operating system and application software on a dedicated PVR is usually pre-loaded and can only be modified by the system operator, for example by downloading software updates over a broadcast channel. This is one of the reasons why dedicated PVRs are more reliable than computer-based PVRs. However, this makes it impossible for a user to load transcoding software onto the dedicated PVR to allow recorded programmes to be played back on a portable media player. Moreover, a dedicated PVR is designed to have sufficient processing power for PVR functions, within a cost budget; there may not be sufficient spare processing power to perform transcoding as well.

Patent publications EP-A-1494375 and WO-A-03043326 disclose PVRs that internally transcode a media file into a format suitable for playback on a mobile device, before exporting the transcoded media file to the mobile device.

Patent publication WO-A-04054258 discloses a plug-in transcoder for a STB that receives a media stream in one format and returns the media stream back to the STB in another format. The transcoded media stream may be sent for local backup on a data storage unit, which may be separate from the transcoder or integrated with the STB or the transcoder.

### STATEMENT OF THE INVENTION

According to one aspect of the present invention, there is provided a transcoding device for transcoding a media file from a first format to a second format, the device including an interface for receiving the media file in the first format, a transcoder for transcoding the media file to the second format, and output means for outputting the media file in the second format. The interface is preferably suitable for connection to a media file store, such as a PVR, so as to receive the media file in the first format from the media file store and transcode the media file to the second format for output to a portable media player (PMP). The device provides the advantage of removing the burden of transcoding from the media file store and from the PMP, neither of which may be suitable for transcoding. The transcoder may be a dedicated transcoder arranged to transcode exclusively from the first format to the second format; for example, the transcoder may be implemented in hardware or firmware. This dedicated transcoding arrangement may provide an efficient transcoder that can be implemented with low power requirements and may be powered through the interface. The user may select the device from a range of such devices having respective dedicated transcoders for a corresponding different range of second formats, so that the second format of the selected device is compatible with the user's PMP.

In one embodiment, the output means is arranged to output the media file over the interface, and the transcoding device includes a memory of sufficient size to store the media file in the second format, and preferably to store a plurality of media files in the second format. In this embodiment, the transcoding device is first connected via the interface to the media file store so as to receive one or more media files in the first format, convert them into the second format, and store them in the memory. The transcoding device is then disconnected from the media file store and connected via the interface to the PMP, so as to transfer the one or more media files to the PMP.

In another embodiment, the interface comprises a first interface of the transcoder device and the output means comprises a second interface of the transcoder device. In this embodiment, the transcoder device may be connected simultaneously to the media file store via the first interface and to the PMP via the second interface. Selected media files are then output from the media file store in the first format over the first interface, transcoded within the transcoding device, and output from the transcoding device in the second format over the second interface to the PMP. As a result, it may not be necessary to store the complete media file within the transcoder device, but the media file may be streamed through the transcoding device, requiring only a buffer memory within the transcoding device. This reduces the memory requirement and therefore the cost of the transcoder device.

### BRIEF DESCRIPTION OF THE DRAWINGS

Specific embodiments of the present invention will now be described with reference to the accompanying drawings, in which:

FIG. 1 is a diagram of a transcoding device in the first embodiment, connected to a PVR;

FIG. 2 is a diagram of the transcoding device in the first embodiment, connected to a PMP; and

FIG. 3 is a diagram of a transcoding device in the second embodiment, connected simultaneously to the PVR and the PMP.

### DETAILED DESCRIPTION OF EMBODIMENTS OF THE INVENTION

### First Embodiment

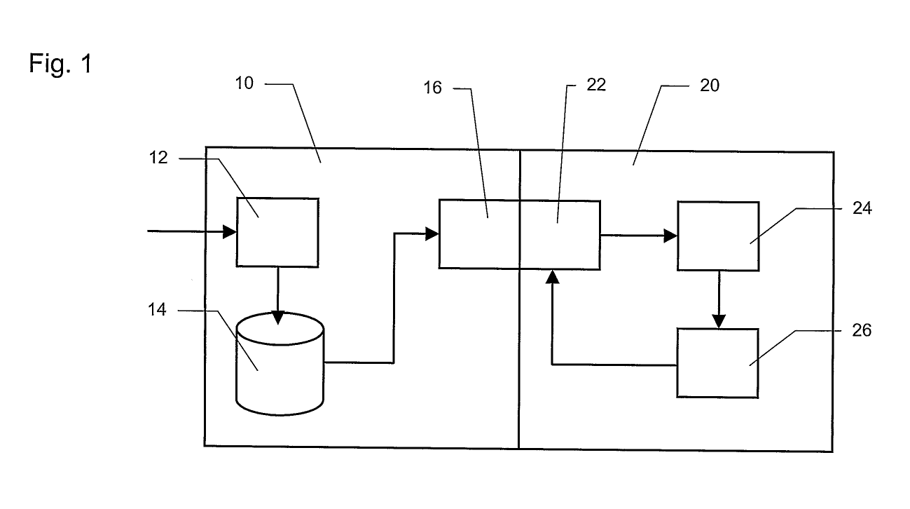

As shown in FIG. 1, a PVR 10 includes a media content receiver 12 for receiving media content and a media store 14 for storing the received media content. The media content receiver 12 may comprise one or more tuners for receiving broadcast programmes. In another example, the media content receiver 12 may comprise a network interface for receiving media content over a network, such as the Internet. The media store 14 may comprise one or more hard discs, a solid-state memory, a recordable optical disc drive or other storage means suitable for storing media files.

The PVR 10 includes an external interface 16. In this embodiment, a transcoding device 20 is connected to the interface 16 by means of a compatible interface 22. The interfaces 16 and 22 may both be Universal Serial Bus (USB) ports, Ethernet or other high-speed data interfaces. The physical connection between the interfaces 16 and 22 may be wired (for example via a USB or Ethernet cable) or wireless (for example using Bluetooth® or W-LAN protocols). A wired connection is preferable as it reduces the complexity of the transcoding device 20.

The PVR 10 includes a user interface (not shown) allowing the user to select media content from an electronic programme guide (EPG) for recording on the media store 14. The user interface also allows media content to be selected from the media store 14 for output to the transcoding device 20 in a first media coding format, which is preferably the coding format in which the media content is stored on the media store 14. The first media coding format may for example be the MPEG-2 (Moving Picture Expert Group-2) format or the MPEG-4 AVC (Advanced Video Coding) format. The media content may comprise standard definition (SD) or high definition (HD) video data.

The transcoding device 20 includes a transcoder 24 that receives the media content in the first format and transcodes it into a second media coding format suitable for playback on a PMP. The second format may be the MPEG-4 format, which allows greater compression than the MPEG-2 format. The media content is then stored in the second format in a memory 26.

The transcoder 24 is preferably a hardware- or firmware-based transcoder arranged to transcode solely between the first format and the second format, for maximum speed and power efficiency. Preferably, the transcoder 24 is powered through the interfaces 16 and 22, so that the transcoder does not require an internal or separate external power supply. Preferably, the memory 26 is a non-volatile memory so that the media content is not lost when the transcoding device 20 is removed from the PVR 10.

The transcoder 24 performs the steps necessary to convert from the first format to the second format, including decoding from the first format and encoding into the second format. Transcoding may be performed on the entire media content stream, or on discrete sections of the media content stream. The encoding step may include a reduction in audio/video resolution, lossy compression and/or a change in video format, for example from HD to SD format.

The first format may include encryption so as to prevent unrestricted access to the media content. In this case, the transcoder 24 accesses a decryption key so as to decrypt the media content so that it can be converted into the second format. The second format may also include encryption, preferably using a different encryption scheme to that of the first format. In that case, the transcoder 24 accesses an encryption key so as to encrypt the media content in the second format. The decryption key and/or the encryption key may be stored securely within the transcoding device 20 and may be loaded into the transcoding device during manufacture or may be obtained from the PVR 10 using a secure key exchange mechanism. The PVR 10 may authenticate the transcoding device 20 before transferring media content, to ensure that media content is only output to an authorised device. For example, the PVR 10 may send an authentication request to the transcoding device, via the interfaces 16 and 22. The transcoding device 20 may send an authentication response, generated using secret information stored within the transcoding device 20. The PVR 10 checks whether the authentication response indicates the presence of the secret information, and if so, judges the transcoding device as authentic and initiates a predetermined key exchange to determine rules and security conditions for the use of the media content. The selected media content is then transferred from the PVR 10 to the transcoding device 20, as described above.

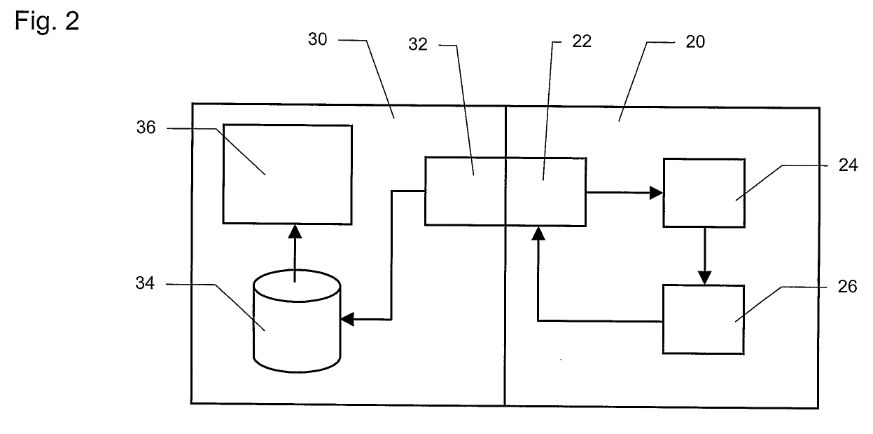

As shown in FIG. 2, the transcoding device 20 is then disconnected from the PVR 10 and subsequently connected, via the interface 22, to a PMP 30 having a compatible interface 32. The transcoding device 20 then transfers the media content in the second format from the memory 26 to a portable media store 34 within the PMP 30. The media content may then be played back from the portable media store 34 to a media output device 36, such as a video display and/or an audio output. The media output device 36 is preferably integrated within the PMP 30. The transfer of media content may be initiated automatically on connection of the transcoding device 20 to the PMP 30, for example under the control of the PMP 30.

The transcoding device 20 may authenticate the PMP 30 before transferring the media content, to ensure that media content is only output to an authorised player. For example, the transcoding device 20 may send an authentication request to the PMP 30, via the interfaces 22 and 32. The PMP 30 may send an authentication response, generated using secret information stored within the PMP 30. The transcoding device 20 checks whether the authentication response indicates the presence of the secret information, and if so, judges the PMP 30 as authentic and initiates a predetermined key exchange to determine rules and security conditions for the use of the media content. The selected media content is then transferred from the transcoding device 20 to the PMP 30, as described above.

In the case where the first format includes encryption but the second format does not include encryption, it is preferred that the second format contains less media information than the first format, so that a user of the PMP 30 does not gain full access to the media content that was protected by encryption in the first format. For example, the second format may be of lower audio and/or video resolution than the first format. The user can therefore play back the media content with a lower quality that may be acceptable on a PMP 30, but does not gain unrestricted access to broadcast-quality media content.

### Second Embodiment

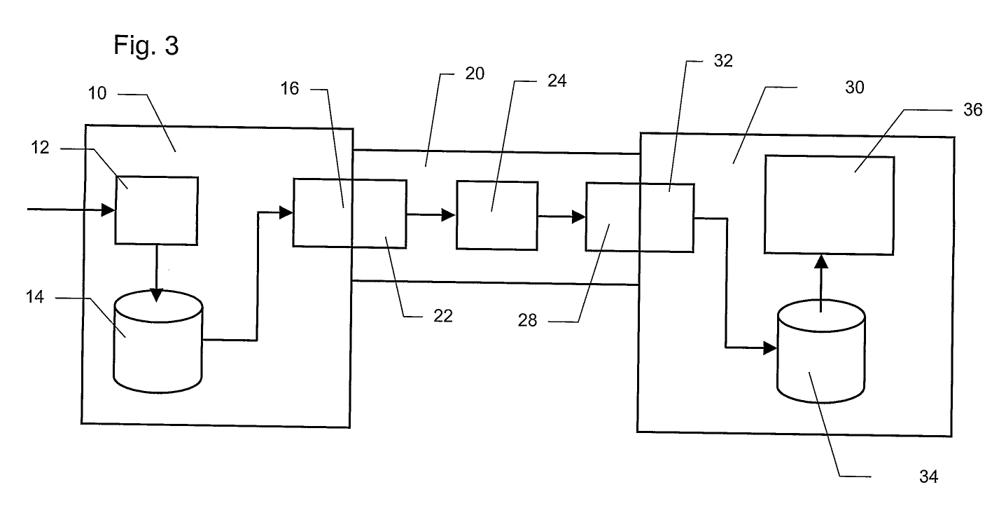

In a second embodiment, as shown in FIG. 3, an alternative transcoding device 20 is used for simultaneous connection between the PVR 10 and the PMP 30. Similar parts to the first embodiment are shown using the same reference numerals and their description is not repeated.

The transcoding device 20 of the second embodiment has a second interface 28 compatible with the interface 32 of the PMP 30. The selected media files are output from the media file store 14 in the first format over the interface 16, transcoded within the transcoding device 20, and output from the transcoding device 20 in the second format over the second interface 28 to the PMP 30. The transcoding device 20 does not need to store the media content in the second format within an internal memory, but streams the media content in the second format over the second interface 28. Only a buffer memory is needed within the transcoder 24. This reduces the memory requirement and therefore the cost of the transcoder device 20, while allowing a larger quantity of media content to be transferred from the PVR 10 to the PMP 30 in a single session.

The transcoding device 20 may decrypt the media content in the first format, and encrypt the media content in the second format, substantially as described in the first embodiment.

Authentication between the PVR 10 and the transcoding device 20, and between the transcoding device 20 and the PMP 30, may take place in a manner similar to the first embodiment.

As with the first embodiment, where the first format includes encryption but the second format does not include encryption, it is preferred that the second form at contains less media information than the first format, so that a user of the PMP 30 does not gain full access to the media content that was protected by encryption in the first format. In other words, the transcoding device performs a lossy conversion between the first and second formats. For example, the second format may be of lower audio and/or video resolution than the first format. The user can therefore play back the media content with a lower quality that may be acceptable on a PMP 30, but does not gain unrestricted access to broadcast-quality media content.

### ALTERNATIVE EMBODIMENTS

The embodiments are described above purely by way of example, and variations may occur to the skilled person on reading the description, which nevertheless fall within the scope of the invention as defined by the claims.

1. A media transcoding device comprising:
a. a first interface for receiving a media content stream in a first media coding format from a media store;
b. a transcoder for transcoding the media content stream from the first media coding format to a second media coding format; and
c. a second interface for outputting the media content stream in a second media coding format to a media player.

2. A device according to claim 1, including a buffer memory for temporary storage of the media content.

3. A device according to claim 1, arranged to be authenticated by the media store via the interface prior to reception of the media content.

4. A device according to claim 1, wherein the first media coding format is an encrypted format and the transcoder is arranged to decrypt the media content from the first media coding format.

5. A device according to claim 1, wherein the second media coding format is an encrypted format and the transcoder is arranged to encrypt the media content in the second media coding format.

6. A device according to claim 5, wherein the second media coding format is an unencrypted format and contains less media content information than the first format.

7. A media transcoding method using a media transcoding device comprising the steps of:
a. simultaneously connecting a first interface for receiving a media content stream in a first media coding format to a media store and a second interface for outputting the media content stream in a second media coding format to a media player; and
b. transcoding the media content from the media store to the media player using the transcoder.

8. A media transcoding method using a media transcoding device having an interface for sending and receiving media content and a transcoder for transcoding the media content from a first media coding format to a second media coding format, the method comprising:
a. connecting the interface to a media store so as to receive media content in the first coding format;
b. transcoding the media content from a first media coding format to a second media coding format using the transcoder;
c. and outputting the media content in the second media coding format when the interface is connected to a media player.

9. The method of claim 8, wherein the media transcoding device includes a store and the method includes storing the media content in the store prior to output to the media player.

10. The method of claim 9, wherein the store is arranged to store the media content in the second media coding format.

11. The method of claim 9, wherein the store is non-volatile.

12. The method of claim 8, including authenticating the media player via the interface prior to outputting the media content.

13. The method of claim 8, including authenticating the media store via the interface prior to reception of the media content therefrom.

14. The method of claim 8, wherein the first media coding format is an encrypted format and the transcoder decrypts the media content from the first media coding format.

15. The method of claim 8, wherein the second media coding format is an encrypted format and the transcoder encrypts the media content in the second media coding format.

16. The method of claim 14, wherein the second media coding format is an unencrypted format and contains less media content information than the first format.

17. The method of claim 8, wherein the media store comprises a media content receiver.

18. A media transcoding device comprising:
a. means for receiving media content in a first, encrypted media coding format;
b. a transcoder for transcoding the media content from the first, encrypted media coding format to a second, decrypted media coding format; and
c. means for outputting the media content in a second media coding format; wherein the second media coding format contains less media content information than the first media coding format.
